(19) United States
(12) Patent Application Publication
(10) Pub. No.: US 2025/0069509 A1
(43) Pub. Date: Feb. 27, 2025

(54) SMART WORK ZONE SYSTEM

(71) Applicant: VIRGINIA TECH INTELLECTUAL PROPERTIES, INC., Blacksburg, VA (US)

(72) Inventors: Michael Mollenhauer, Blacksburg, VA (US); Jean Paul Talledo Vilela, Blacksburg, VA (US); Elizabeth White, Blacksburg, VA (US); Christopher A Cox, Christianburg, VA (US); Nazila Roofigari-Esfahan, Blacksburg, VA (US); Sidhant Singhal, Boston, MA (US)

(21) Appl. No.: 18/726,259

(22) PCT Filed: Nov. 14, 2022
(86) PCT No.: PCT/US22/79805

§ 371 Date: Jul. 2, 2024

Related U.S. Application Data
(60) Provisional application No. 63/298,719, filed on Jan. 12, 2022.

(51) Int. Cl. G08G 1/16; G08B 7/06; G08B 21/02; G08B 25/00; G08B 25/01; G08B 25/10; G08B 31/00; H04W 4/02; H04W 4/021; H04W 4/44; H04W 4/90

(52) U.S. Cl. CPC G08G 1/164; G08B 7/06; G08B 21/02; G08B 25/009; G08B 25/016; G08B 25/10; G08B 31/00; G08G 1/166; H04W 4/021; H04W 4/025; H04W 4/44; H04W 4/90

(57) ABSTRACT

Various embodiments of a system and method for a smart work zone are described. In one example, the system includes smart cone devices configured to transmit smart cone device localization data, a wearable device comprising a processor configured to transmit worker localization data of a worker wearing the garment device and to receive an alert, and a base station. The base station includes an internal edge computing system configured to process the smart cone device localization data to define a virtual geofence boundary of a safe area, process the worker localization data, broadcast a location of the worker wearing the wearable device, and in response to a vehicle or the worker approaching the virtual geofence boundary, provide an alert to at least one of: the worker wearing the wearable device, a passing motorist, or a connected and automated vehicle (CAV).

### CROSS-REFERENCE TO RELATED APPLICATIONS

This application claims the benefit of and priority to U.S. Provisional Application No. 63/298,719, entitled “SMART WORK ZONE SYSTEM,” and filed on Jan. 12, 2022, which is incorporated herein by reference in its entirety.

### FEDERALLY SPONSORED RESEARCH STATEMENT

This invention was made with government support under agreement No. 451453 awarded by the Department of Transportation (FHWA). The government has certain rights in the invention.

### BACKGROUND

A work zone is an area of a trafficway with highway construction, maintenance, or utility work activities. A work zone is typically marked by signs, channeling devices, barriers, pavement markings, and/or work vehicles. Drivers may be directed to reduce their vehicle's speed through the work zone for safety reasons.

### BRIEF DESCRIPTION OF DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates an example of a smart work zone system according to various embodiments described herein.

FIG. 2 illustrates the main components for the vehicle-to-everything base station of the smart work zone system of FIG. 1 according to various embodiments described herein.

FIG. 3 illustrates an example of a GNSS/RTK implementation of a smart work zone system according to various embodiments described herein.

FIGS. 4A-4D illustrate examples of a Smart Vest pouch configured to hold the Smart Vest garment device according to various embodiments described herein.

FIGS. 5A and 5B show examples of an add-on smart cone device according to various embodiments described herein.

FIGS. 6A-6C illustrate an example safety area created by smart cones and threat areas in the work zone according to various embodiments described herein.

FIGS. 7A-7D illustrate an example of safety area polygon generation according to various embodiments described herein.

FIGS. 8A-8D illustrate several views of an example add-on smart cone device according to various embodiments described herein.

FIGS. 9A-9D illustrate several views of a first portion of the clamp for the add-on smart cone device in FIGS. 8A-8D according to various embodiments described herein.

FIGS. 10A-10D illustrate several views of a second portion of the clamp for the add-on smart cone device in FIGS. 8A-8D according to various embodiments described herein.

FIG. 11 shows a perspective view of one example of a Smart Helmet device that is configured to attach to a helmet according to various embodiments described herein.

### DETAILED DESCRIPTION

Various examples of a smart work zone system are disclosed herein. The Smart Work Zone (SWZ) system is a package that supports providing alerts to work zone workers and passing motorists including connected and automated vehicles (CAVs) when a potential collision is imminent or when the wearer is about to cross a safe area geofence boundary. The SWZ system includes three main subsystems: (1) a Smart Vest device, (2) a Smart Cone device, and (3) a SWZ Base Station, which may be a Cellular Vehicle-to-Everything (C-V2X) base station. The Smart Work Zone system can be configured within a work zone to support multiple Smart Vest and Smart Cone devices but typically may use one SWZ C-V2X Base Station. If the work zone geography is particularly large, multiple Smart Cone devices provide larger communication coverage with the SWZ Base Station. For example, the Smart Cone device can provide extended coverage by re-broadcasting the wireless packets between the Smart Vest and Base Station. In this way, coverage can be provided along a lengthy work zone that may span a number of miles, potentially with only one SWZ Base Station.

The SWZ system may provide warnings, alerts, or related notifications to workers based on one or more of the following two scenarios: (1) when a worker is approaching or has exceeded a geofence boundary that has been defined for a work zone, and (2) when a C-V2X-equipped connected vehicle is on a trajectory to collide, or to nearly collide, with the vest wearer and a minimum time-to-collision threshold between them has been reached. In addition, the SWZ Base Station may use a C-V2X Roadside Unit (RSU) to broadcast the location of the Smart Vest wearers to vehicles equipped with a C-V2X onboard unit (OBU) when they are within range of the SWZ Base Station using the Society of Automotive Engineers (SAE) J2735 standard, for example, or a related communications protocol.

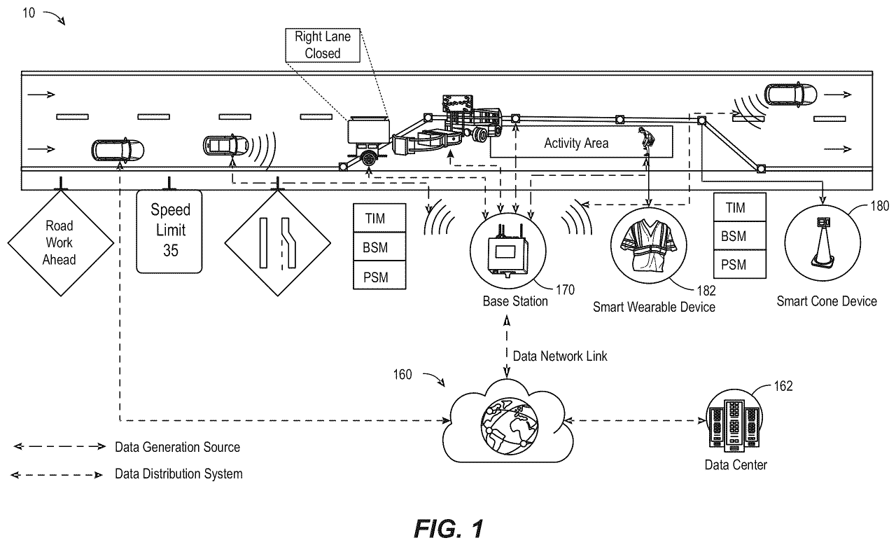

In some embodiments, the system can communicate with cloud server applications via a cellular data interface to upload the locations of Smart Vest wearers, Smart Cones, and the locations of connected and automated vehicles near the work zone. The SWZ Base Station may also download the locations of equipped vehicles that are out of range of the local RSU, along with information about the work zone geometry, reduced speed limits, and special hazards so they may be broadcast to passing vehicles when the passing vehicles are within range using the SAE J2735 standard. FIG. 1 shows the described elements in a typical work zone deployment including a Cellular Vehicle to Everything (C-V2X) Base Station, a smart vest device, and a smart cone device.

Turning to the drawings, the following paragraphs provide an outline of a networked environment followed by a discussion of the operation of the same. FIG. 1 illustrates an example of networked environment 10 for a smart work zone system according to various examples described herein. Among others not illustrated, the networked environment 10 includes a network 160, a base station computing device 170, one or more smart cone devices 180 (also “Smart Cones”), and one or more smart wearable devices 182, such as smart vest devices (also “Smart Vests”) or smart helmet devices (also “Smart Helmets”), among possibly other devices. The base station computing device 170, smart cone devices 180, and smart wearable devices 182 can be communicatively coupled together through the network 160.

The network 160 can include the Internet, intranets, extranets, wide area networks (WANs), local area networks (LANs), wired networks, wireless networks, cable networks, cellular networks, satellite networks, other suitable networks, or any combinations thereof. The base station computing device 170, the smart cone devices 180, and the smart wearable devices 182 can, respectively, be communicatively coupled among each other, using one or more public or private LANs or WANs, and to the network 160 for communication of data among each other. Although not shown in FIG. 1, the network 160 can also include network connections to any number and type of network hosts or devices, such as website servers, file servers, cloud computing resources, databases, data stores, and other network or computing architectures. For example, network 160 can be a cellular or wireless network (e.g., 4G, 5G, XBee, etc.).

In the networked environment 10, the base station computing device 170, smart cone devices 180, and smart wearable devices 182 may communicate with each other through various public or private application programming interfaces (APIs) or other suitable interfaces. Such communications can occur using various data transfer protocols and systems interconnect frameworks, such as hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), standard connected vehicle communications protocols (C-V2X/PC5), other protocols and interconnect frameworks, and combinations thereof.

The base station computing device 170 can be embodied as a computer, computing device, or computing system including one or more processors, processing devices, and memory devices. The base station computing device 170 can be a single or standalone device in one example. In other cases, the base station computing device 170 can be embodied as one or more computing devices arranged, for example, in one or more server or computer banks in a data center.

The smart cone devices 180 and smart wearable devices 182 can be embodied as any suitable computing devices including processors and memories, including those in the form of embedded computing devices, desktop computers, laptop computers, personal digital assistants, cellular telephones, tablet computers, or other related computing device or system.

As shown in FIG. 1, the base station computing device 170 operates as a type of vehicle-to-everything base station, and the base station computing device 170 functions as the core of the SWZ System. In an example, base station computing device 170, which is also referenced as a vehicle-to-everything base station or a SWZ Base Station, can be a C-V2X Base Station that supports C-V2X technology. The base station computing device 170 may communicate with the Smart Vests, Smart Helmets, and/or Smart Cones over a mesh network sending real-time kinematic positioning (RTK) corrections and alert messages to the Smart Vests and/or Smart Helmets, while receiving localization information from one or more of the Smart Vests, Smart Helmets, or Smart Cones. The SWZ Base Station may include an internal edge computing system that runs algorithms on the consolidated data to determine whether any warnings need to be issued. In other embodiments, the SWZ Base Station may communicate to a cloud computing system or another off-site computing system in order to execute the algorithms. The SWZ Base Station may include an RSU to support standard C-V2X/PC5 connected vehicle communications protocols which allows data packet exchange between the RSU and CAVs using standard SAE J2735 Basic Safety Messages (BSMs) and Personal Safety Messages (PSMs). CAVs approaching the work zone may communicate with a cloud server over a cellular data network to receive generalized information about the location and configuration of a work zone. For example, the generalized information about the location and configuration of a work zone can be provided in GeoJSON format.

For example, as the vehicle approaches the intersection, the vehicle broadcasts its BSMs, which contain its speed, location, acceleration, etc. at 10 Hz or another periodic frequency of broadcast of the information. Once within range, the RSU begins to receive the BSMs from the vehicle and forwards them to one or more of an internal edge computing system or to a cloud server (if equipped with a cellular data modem). At the same time, the SWZ Base Station broadcasts all PSMs derived from Smart Vest and/or Smart Helmet wearer locations to the vehicle at 10 Hz or another frequency. The vehicle is responsible for consuming the PSMs and evaluating whether any action (e.g., a driver alert or automated response) is required based at least in part on determining a potential collision with the Smart Vest or Smart Helmet wearer. The SWZ Base Station may have geographic definitions of safe areas that are defined either through its local GNSS plotting device, through a download of work zone geographic data from the cloud server over the cellular data network, or through the locations of deployed Smart Cones.

On the SWZ Base Station in one embodiment, the internal edge computing system processes all the BSMs received from passing vehicles along with Smart Vest, Smart Helmet, and Smart Cone localization data the SWZ base station has received over the mesh network. The SWZ Base Station may run an algorithm to process both collision trajectories and position information relative to geofenced areas and send alerting instructions to any Smart Vests or Smart Helmets that need to be triggered. The Smart Work Zone Base Station may include a cellular data link which allows pushing data including both the BSMs and PSMs to a cloud work zone information system.

The localization data can include absolute and relative locations for the Smart Vest, Smart Helmet, Smart Cone, and other equipment that can be identified. As one example, the SWZ Base Station can utilize the Smart Cone localization data to define a virtual geofence boundary for a safe area based at least in part on the absolute location(s) of the deployed Smart Cones. The relative locations of the Smart Vests and/or Smart Helmets to the geofence boundary or Smart Cones can trigger an alert. Alternatively, any of the base station, Smart Cone, Smart Helmet, or Smart Vest can receive the localization data to determine the proximity to the geofence boundary.

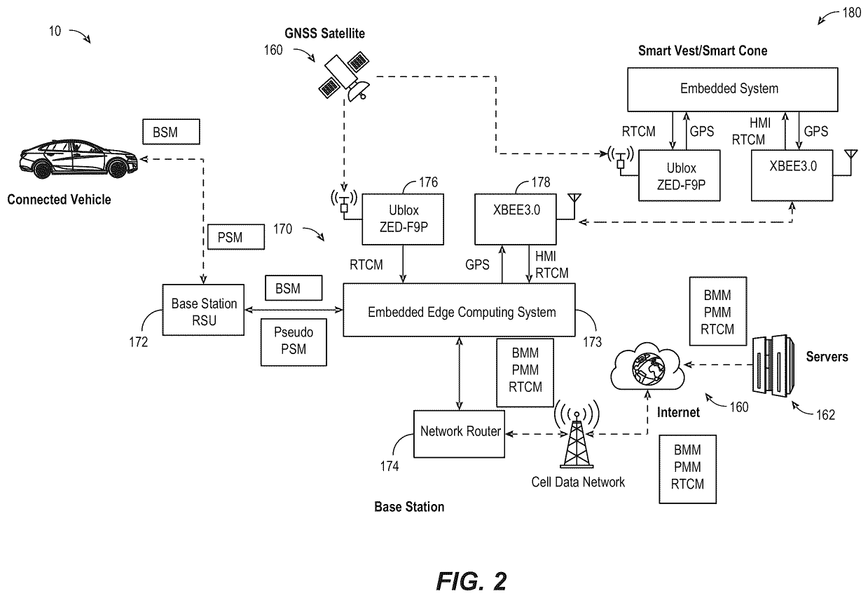

As shown in the example in FIG. 2, the base station computing device 170 can integrate different hardware components to support C-V2X communications, generation of GNSS/RTK corrections, and communicate with the Smart Vest, Smart Helmet, and Smart Cone devices. The system has all the necessary components to run algorithms for geofencing and collision warning using localization data inside an embedded edge computing system. The main components for the C-V2X Base Station 170 can include: C-V2X RSU 172, Embedded Edge Computing system 173, Network Router 174, Ublox ZED-F9P module 176, and XBee DigiMesh Transceiver 178. The Base Station 170 can omit one or more of those components, however, in some cases.

The C-V2X RSU device 172 of the vehicle-to-everything base station provides V2X technology support to the SWZ system. C-V2X RSU device 172 is capable to receive Basic Safety Messages (BSMs) from Vehicles and forward them to the embedded edge computing system and create and encode Personal Safety Messages (PSMs) using the localization data received for the Smart Vest and/or Smart Helmet devices from the embedded edge computing system. Another capability for the C-V2X RSU is the Traveler Information Message (TIMs) packet transmission related to the work zone deployment using GeoJSON work zone definition which is received from an off-site server. In one example, the base station incorporates a C-V2X RSU device, although similar cellular vehicle-to-everything devices can be implemented and relied upon in other configurations of the system.

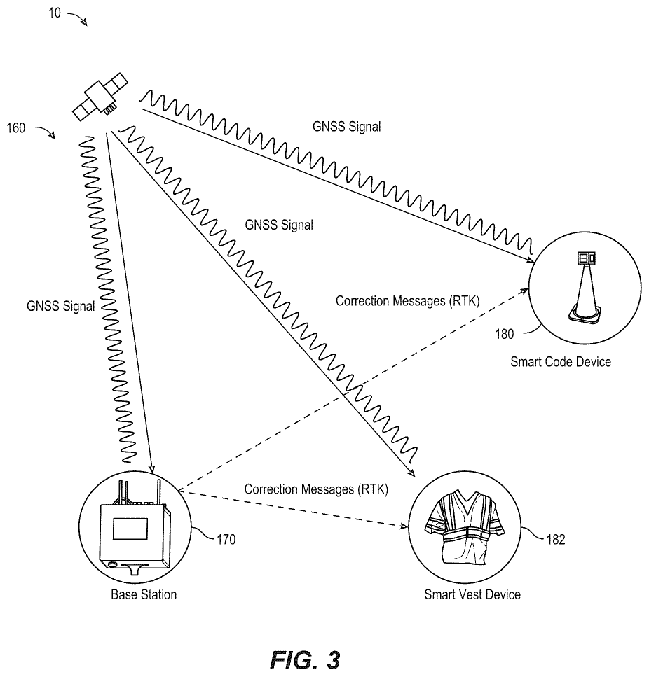

The embedded edge computing system 173 can interface with the C-V2X RSU using TCP/UDP connections over Ethernet link, forward Radio Technical Commission for Maritime Services (RTCM) packets or RTK packets, receive GPS data, and send Human Machine Interface (HMI) commands over the XBEE DigiMesh link. As shown in FIG. 3, the embedded edge computing system can also act as GNSS/RTK Base station by configuring the Ublox ZED-F9P device in base station mode and receiving the RTCM packets after the surveying process is complete. In one implementation, an average of 15 minutes elapses for the base station to start broadcasting RTCM/RTK packets to all the Smart Vest/Smart Cone/Smart Helmet devices. The embedded edge computing system 173 can be embodied as a computer, computing device, or computing system. For example, the embedded edge computing system 173 can be a single board computer.

The embedded edge computing system can queue all the BSMs and Smart Vest/Helmet/Cone localization data and process them to generate the proper HMI alerts which can be transmitted to the Smart Vest and other devices accordingly. The Smart Cone localization data can be used to compute and calculate which Smart Vest devices, for example, are within the geofence created by the Smart Cone devices. This virtual geofence can be used to detect which Smart Vest devices are inside the “safe area.” For BSM processing, embedded edge computing systems can use distance and time to collision (TTC) calculations to determine which Smart Vest or Smart Helmet should be notified for a vehicle passing nearby.

The Data Router 174 of the vehicle-to-everything base station provides an M2M Link between the Smart Work Zone C-V2X Base Station and an off-site server. This link provides VPN and low latency connectivity. The C-V2X RSU uses this link to retrieve a GeoJSON work zone definition for deployment which is subsequently converted into SAE J2735 Traveler Information Messages (TIMs). At the same time, BSMs and PSMs may be forwarded to a cloud server for monitoring and storage purposes.

The embedded edge computing system uses the 4G Link to download RTCM/RTK corrections when a local GPS RTK survey is not possible and to upload BSMs and PSMs to the cloud as Basic Mobility Message and Personal Mobility Message when the C-V2X RSU is not operational. In one example, the base station incorporates a 4G Router, although similar cellular routers can be implemented and relied upon in other configurations of the system.

The ZED-F9P module 176 of the vehicle-to-everything base station is a top-of-the-line module for high accuracy GNSS and GPS location solutions including RTK that is capable of 10 mm, three-dimensional accuracy. The ZED-F9P is unique in that it is capable of both rover and base station operations. The Smart Work Zone system uses both capabilities (Base Station and Rover) to get the best GPS computation solution and provide reliable localization data to the internal algorithms. In one example, the base station incorporates a ZED-F9P module, although similar modules can be implemented and relied upon in other configurations of the system.

The Smart Work Zone system can use XBEE 3 Pro Modules 178 for the internal wireless communications which provide mesh network capabilities, covering 300 feet indoor or 500 meters outdoor, line of sight range. The system in some embodiments can support multiple variants for the radio, including internal PCB antennas and external antenna through an SMA connector, which provides flexibility for medium and long-range coverage. In one example, the base station incorporates XBEE modules, although similar radio-frequency (RF) modules can be implemented and relied upon in other configurations of the system.

As shown in FIG. 1, the base station computing device 170 can communicate with the smart wearable devices 182 over a mesh network. The smart wearable devices 182 correspond to wearable Personal Protective Equipment, such as a helmet or vest that includes a device comprising a battery and electronics package that accurately localizes the wearer and transmits its location to the C-V2X Base Station for monitoring and predicting nearby collision threats and geofence boundaries. A processor integrated into the Smart Vest or Smart Helmet system processes the alert requests from the C-V2X Base Station, and the processing predicts potential collisions between work zone workers and passing motorists. The Smart Vest and/or Smart Helmet may have multiple complementary human-machine interface outputs integrated into its design including auditory, visual, and tactile feedback that can be used to warn the wearer of a collision threat or geofence boundary-crossing as needed.

In one example, the Smart Vest garment device integrates three main elements, including a 32-bit ARM-based microprocessor, a Ublox ZED-F9P GNSS receiver, and the XBEE 3 Pro module in a PCB board and has a connector for the HMI interface including buzzers, LEDs, and tactors. A hardware PCB board is designed to house all the necessary electronic components to provide the required functionality using a USB battery pack.

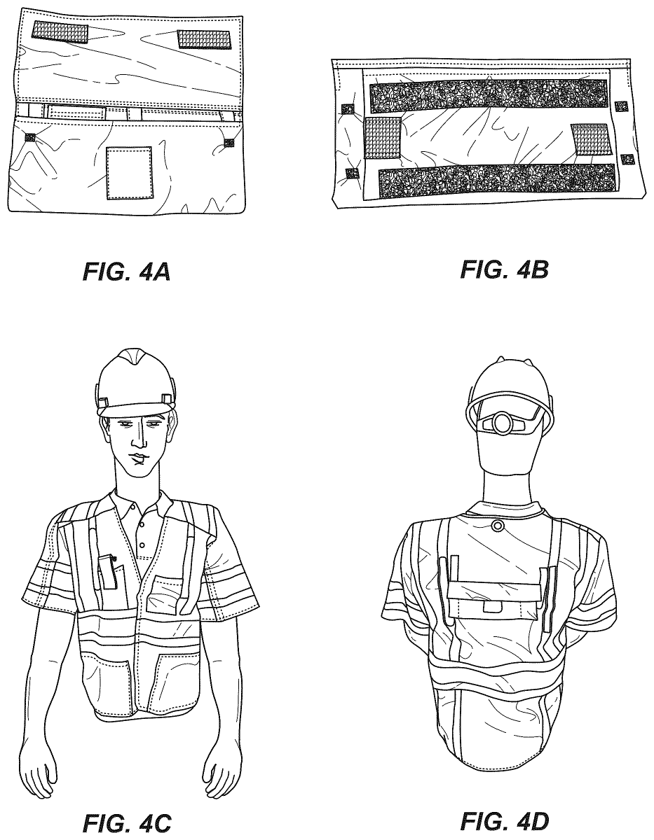

FIGS. 4A-4D illustrate examples of a Smart Vest pouch configured to hold the Smart Vest garment device. Shown in FIG. 4A is a front view of the Smart Vest pouch. The pouch is configured to receive inside the Smart Vest garment device including the Smart Vest PCB (hardware) board. USB battery, and speakers. As shown in FIG. 4B, the back view of the Smart Vest pouch is configured to attach to a Class 3 Vest by hook and loop fastener, such as Velcro® lines, and is supported for the tactile motors. FIGS. 4C and 4D shows an example of the front and back views of a Class 3 Vest from NITEBEAMS, where the Smart Vest pouch is attached to the back. While this example shows one brand of a Class 3 safety vest, the Smart Vest garment device can be implemented and relied upon in other configurations of garments worn by a worker.

The main function of the Smart Vest device is to provide precise GPS data to the C-V2X Base Station. The Smart Vest device can process any HMI triggering requests to alert the worker about the following situations, among possibly others: close to a virtual geofence border, exiting a virtual geofence border, and vehicle on a potential collision course.

In one example, the Smart Vest hardware board includes 6 connectors for the HMI interface: 2×LED, 2×Buzzer, and 2×Tactile control signals. The 32-bit ARM microprocessor is an STM32F306 MCU running at 72 MHZ and capable of processing the RTCM/RTK packets, HMI control requests, and forwarding GPS data to the C-V2X Base Station. The XBEE 3 Pro module attaches to the PCB hardware and the enclosure so that the electronics are protected when the garment device is installed in the Smart Vest.

In an example, the Smart Vest can include a commercially available NITEBEAMS Class 3 work zone vest with Light Emitting Diodes (LEDs) that integrates all the remaining necessary Smart Vest components to support the Smart Vest concept. This work zone vest features embedded LED lights in the front and back. The LED lights can be disconnected from the NITEBEAMS battery and controlled by the Smart Vest hardware package, with some re-wiring to re-route the control signals.

The vest can also have a compact, lightweight padded fabric pouch that is designed to store all the hardware electronics, Universal Serial Bus (USB) battery pack, and interface wiring to the HMI elements. In one embodiment, the fabric pouch is fully detachable from the work zone vest providing flexibility for electronics maintenance, garment maintenance, or swapping to a different vest as well.

As shown in FIG. 1, the vehicle-to-everything base station can communicate with the Smart Cones over a mesh network. The Smart Cone device 182 is an add-on hardware component that can be attached to a work zone drum or cone. It defines the boundaries of a safe area which can be dynamically adjusted or moved based on the work zone configuration. In various embodiment, another benefit of the Smart Cone is to make the wireless link between the Smart Work Zone Base Station and the Smart Vest devices more robust by acting as a repeater or router on the wireless mesh network.

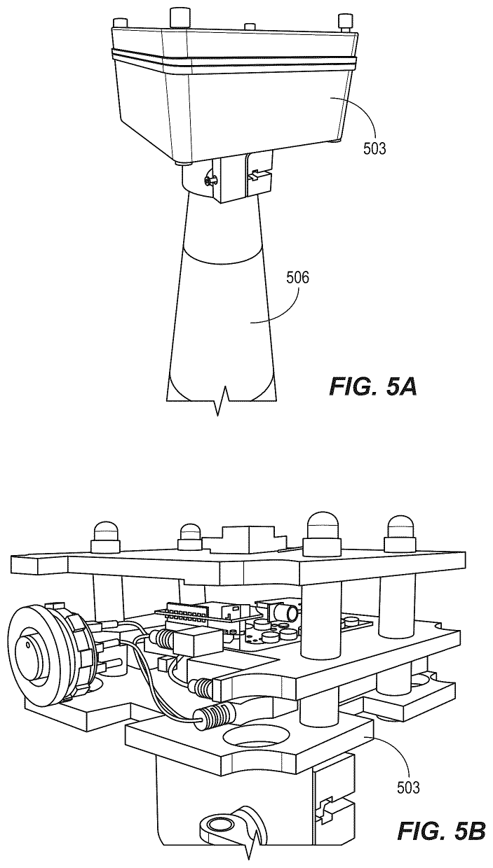

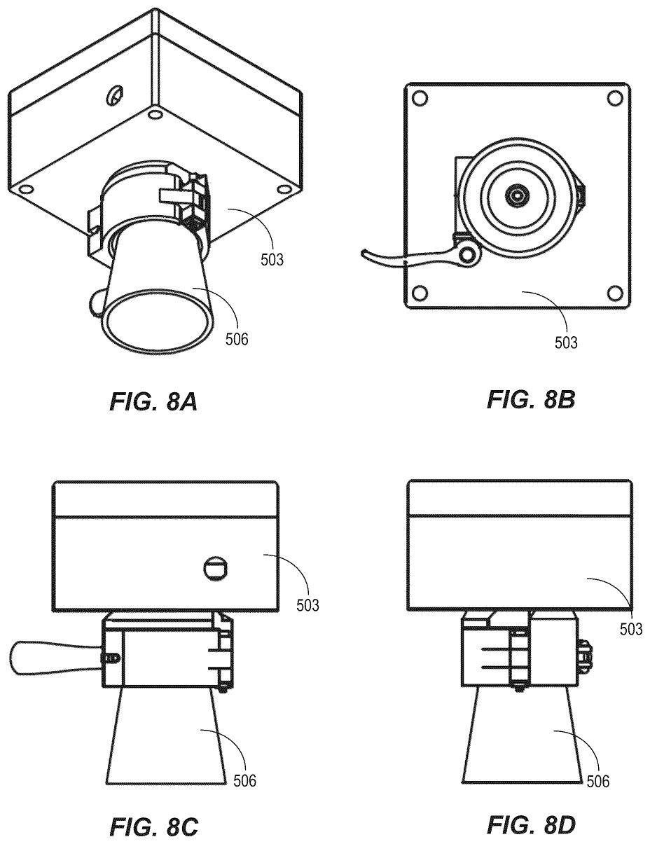

The Smart Cone device uses the same electronics as the Smart Vest device with the addition of a control signal for an external light triggering (solid/pulsing). FIG. 5A shows an example of an add-on smart cone device 503 attached to a work zone cone 506. As shown, the add-on smart cone device 503 is clamped to the top of a safety cone 506. FIG. 5B shows an example of an assembly view of the smart cone device 503. An example enclosure for the electronics is shown in FIGS. 8A-8D. The Smart Cone device 503 can be attached to a work zone cone 506, a drum, or other equipment defining the perimeter of a safe area.

In one embodiment, Smart Cone devices 503 can provide GNSS localization data to the C-V2X Base Station which can process them and create a virtual geofence that can be adjusted if any of the cones are moved or turned on/off.

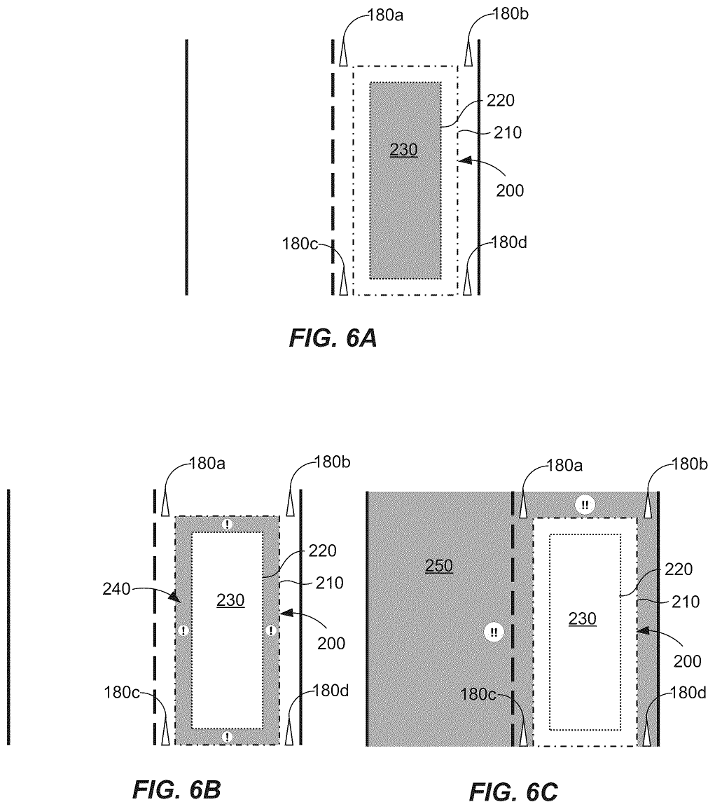

FIGS. 6A-6C illustrate an example safety area 200 created by the location of smart cones 180 in the work zone. For example, in FIGS. 6A-6C, each deployed smart cone 180a-180d (collectively smart cones 180) defines a vertex of a polygon defining a safety area 200. As shown in FIG. 6A, the polygon border of a work zone geofence boundary 210 for the safety area 200 is shown as an outer perimeter. A safeguard boundary 220 is shown as an inner perimeter for the generated polygon using smart cones and is created at a distance from the work zone geofence boundary 210 forming a pseudo-safety area 230 to provide a warning that the work zone geofence boundary is nearby. For example, the safeguard boundary 220 may be set at a distance of 2 meters inside the work zone geofence boundary 210. Shown in FIG. 6B, the area between the safety area 200 and the polygon border of the work zone geofence boundary 210 defines a low-threat area 240. An alert may be generated when a worker wearing a smart vest is detected in this low-threat area 240 or a vehicle is on a trajectory to collide. As shown in FIG. 6C, the area outside the polygon border of the work zone geofence boundary 210 is considered high-level threat area 250.

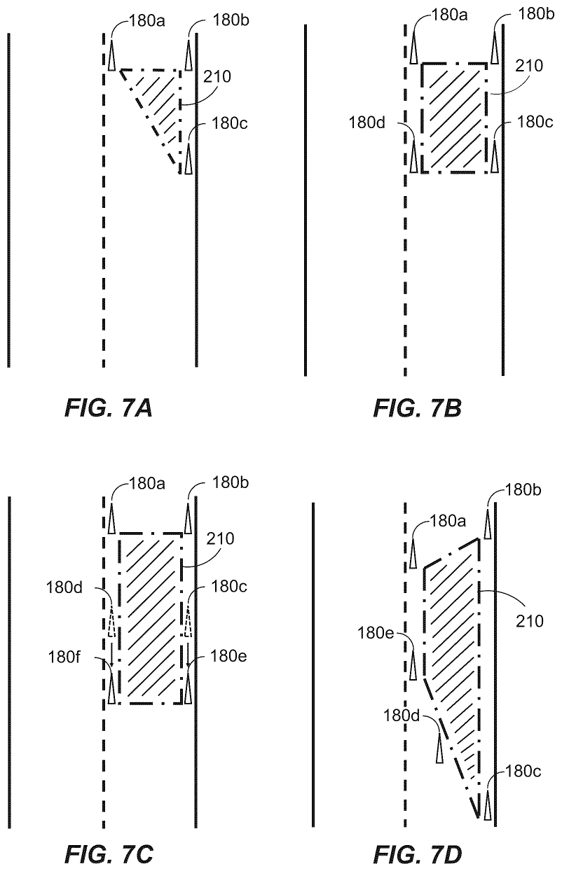

Shown in FIGS. 7A-7D are example safety area polygon generations for the work zone geofence boundaries 210. Each smart cone defines a vertex of the polygon border of the work zone geofence boundary 210. As shown in FIG. 7A, the system relies upon at least three deployed smart cones 180a-180c to generate polygons for the work zone boundary 210. FIG. 7B shows the work zone boundary 210 with four deployed smart cones 180a-180d forming the vertices. The work zone boundary 210 can be moved as needed and the polygon area will be updated. As shown in FIG. 7C, the deployed smart cones 180a-180d mark the old boundary (FIG. 7B), and deployed smart cones 180a, 180b, 180e, and 180f mark the new work zone boundary 200. As shown in FIG. 7D, adding more smart cones to the work zone 210 will create a new polygon with new vertices.

Another function of the Smart Cone device is the ability to extend the XBEE 3 Wireless mesh network by acting as a bridge/router role. This feature can allow extending the work zone area longer than 500 meters which is the current range from the C-V2X Base station and any other Smart Vest, Smart Helmet, or Smart Cone device.

Referring back to FIG. 5B, the hardware assembly can include an external work zone light which can be optional to the assembly but provides the ability to create basic patterns to alert drivers when entering a work zone activity area. In an example, the hardware assembly can include a clamp to attach the add-on smart cone device to a work zone cone, a drum, or other equipment defining the perimeter of a safe area.

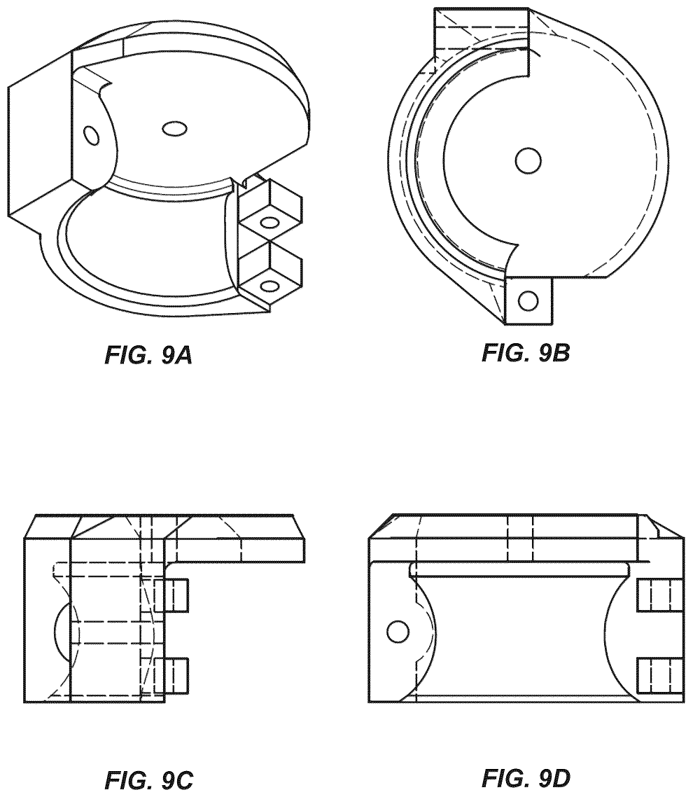

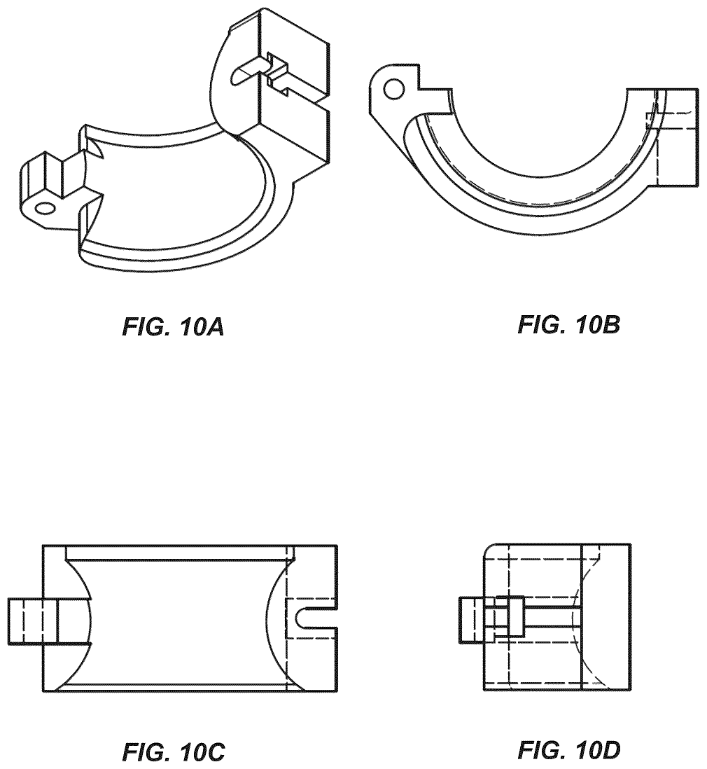

FIG. 8A illustrates an example of an add-on smart cone device 503 that can be attached to a work zone drum or cone 506. FIGS. 8B-8D show top, side, and front views of the add-on smart cone device shown in FIG. 8A. FIG. 9A shows an example of a first portion of a clamp used for the add-on smart cone device shown in FIG. 8A. FIGS. 9B-9D show top, side, and front views of the first portion of a clamp used for the add-on smart cone device shown in FIG. 9A. FIG. 10A shows an example of a second portion of the clamp used for the add-on smart cone device shown in FIG. 8A. FIGS. 10B-10D show top, side, and front views of the second portion of the clamp used for the add-on smart cone device shown in FIG. 10A.

As shown in the example of FIG. 2, the Smart Work Zone system can make use of several commercial technologies that have been integrated into the three subsystems: GNSS RTK, C-V2X, and XBee DigiMesh. In various embodiments, the system incorporates a GNSS/GPS receiver with RTK support as a core technology providing precise localization of the sub-system devices along with a wireless mesh network communicating between all the sub-systems for internal data packet exchange.

GNSS RTK, or Real-Time Kinematic, is a GNSS/GPS technique used to enhance the precision of position data received from satellite-based positioning systems through the position of correction data in real-time. GNSS RTK uses carrier-based ranging rather than code-based positioning and relies on a single reference station to provide real-time corrections. The application of RTK corrections results in centimeter-level accuracy which is often required for applications such as surveying or other high-precision applications. GPS makes use of RTK to reduce and remove common tracking errors by monitoring signals from satellites, surveying their location from a fixed position, and communicating a corrected position to other nearby users to apply correction algorithms as they resolve their localization solutions.

FIG. 3 shows the Smart Work Zone system GNSS/RTK configuration. The C-V2X Base Station acts as the RTK base station which requires a minimum of 15 minutes after startup to survey satellite signals and start broadcasting the RTK corrections. Smart Vest, Smart Helmet, and Smart Cone devices receive the RTK corrections from the C-V2X Base Station to provide precise GPS positioning.

Cellular vehicle-to-everything (C-V2X) technology is developed within the 3^{rd} Generation Partnership Project (3GPP) communications standard designed to achieve vehicle-to-vehicle (V2V), vehicle-to-infrastructure (V2I), vehicle-to-network (V2N), and vehicle-to-pedestrian (V2P) communication, which has now rapidly gained popularity in connected vehicles on the market. C-V2X communications are likely to become essential to support fully autonomous self-driving vehicles in future smart cities. C-V2X can be deployed in use cases such as an emergency vehicle warning, a pre-crash sensing warning, a road safety warning, an intersection movement assist, and a collision warning.

The Smart Work Zone system can incorporate a C-V2X to extend the alert messages not only for workers inside the work zone deployment but also to exchange data with C-V2X equipped vehicles passing nearby. C-V2X equipped vehicles can broadcast the SAE J2735 Basic Safety Messages (BSMs) and the C-V2X Base Station can broadcast SAE J2735 Personal Safety Messages (PSMs) that provide RTK-corrected GPS locations for each of the Smart Cones and workers who are wearing the Smart Vest devices.

DIGI XBee3™ Zigbee RF Modules provide a small smart IoT End-node for applications that need to acquire and process data at the end device and send only actionable data upstream in the network. DIGI XBee3 modules are fully integrated, certified, and ready to connect to wireless mesh networks. The XBee3 can be used for applications that require small, efficient design, and need control logic at the endpoint to eliminate separate microcontrollers. The modules offer flexibility to mesh networking enabling a higher level of abstraction and allowing configuration changes in real-time. The Smart Work Zone system can use XBee3 DigiMesh technology to exchange GNSS RTCM corrections and GPS data packets between the base station, the Smart Vest, the Smart Helmet, and the Smart Cone devices and to send HMI alerts triggering packets back to the Smart Vests and/or Smart Helmets when appropriate.

The Smart Work Zone system is a solution that supports C-V2X technology, GNSS/RTK, and wireless XBee link. The system can communicate with a vehicle using the C-V2X Base Station when they are approaching a work zone and there are workers nearby. At the same time, the system alerts workers wearing the Smart Vest or Smart Helmet when approaching the boundaries of the activity area or when a vehicle is approaching or nearby.

The system in some embodiments may use GNSS/RTK technology to compute a precise Worker localization inside the work zone deployment and to generate a virtual geofence using the Smart Cone devices. In addition, the system can have a Cellular Data Link to off-site servers to upload vehicle, worker, and work zone information or retrieve for message broadcasting over C-V2X as well.

The Smart Work Zone system is a package that supports providing alerts to work zone workers and passing motorists including connected and automated vehicles (CAVs) when a potential collision is imminent or when the wearer is about to cross a safe area geofence boundary. The system includes multiple subsystems: (1) a Smart Vest device, (2) a Smart Cone device, (3) a Smart Helmet device, and/or (4) the Smart Work Zone Base Station. The system uses a GNSS/GPS receiver with RTK support as a core technology providing precise localization of the sub-system devices, and a wireless mesh network between all the sub-systems for internal communication and data packet exchange.

The Smart Vest device is a wearable Personal Protective Equipment vest that includes a battery and an electronics package that accurately localizes the wearer and monitors data from nearby collision threats and geofence boundaries. A processor integrated into the vest predicts potential collision between work zone workers and passing motorists. The Smart Vest can have three complementary human-machine interface outputs integrated into its design including auditory, visual, and tactile feedback that can be used to warn the wearer of a collision threat or geofence boundary crossing, as needed.

The Smart Cone device is an add-on hardware component that can be attached to a work zone drum or cone. It defines the boundaries of a safe area which can be dynamically adjusted or moved based on the work zone configuration. Another benefit of the Smart Cone is to make the wireless link between the Smart Work Zone Base Station and the Smart Vest devices more robust by acting as a repeater/router on the wireless mesh network.

The Smart Work Zone Base Station system includes the required hardware to support C-V2X/PC5 communications which allows packet exchange for SAE J2735 Basic Safety Messages (BSMs) and Personal Safety Message (PSMs) between CAVs and vest wearers. The BSM and PSM packets may be forwarded to two destinations: the cloud which can be consumed at the Data Center and to the internal edge computing system. The internal edge computing system processes all the BSMs, Smart Vest, and Smart Cone localization data and runs an algorithm to process the defined safe geofenced areas to produce the alerts that should be triggered. The Smart Work Zone Base Station includes a 4G Link which allows pushing the data including both the BSM's and PSMs to a cloud work zone information system.

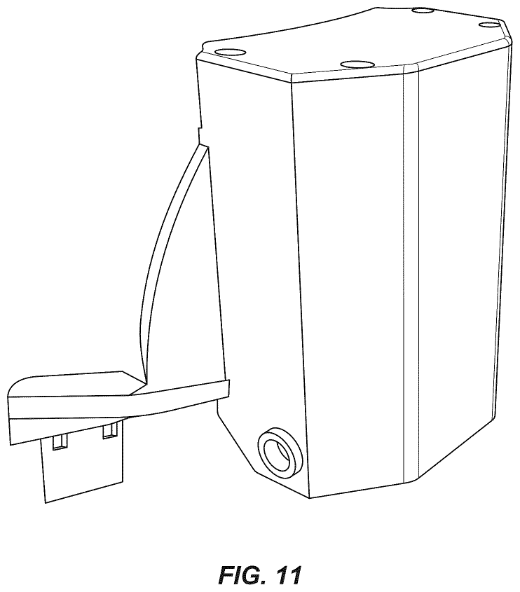

FIG. 11 shows a perspective view of one example of a Smart Helmet device that is configured to attach to a helmet. In various embodiments, the Smart Helmet locates the Smart Work Zone worker package otherwise stored in a high-visibility vest into a compact helmet attachment. In one example, the Smart Helmet package is intended to be used with the KASK ZENITH and ZENITH X hard hats inclusive of the “Air” variations. The Smart Helmet package may be used in other helmets in other examples. For example, the two-piece apparatus may be designed to clip into the existing slots on the front and rear of the helmets, with no tools required.

Contained in the rear component may be one or more of: the SWZ printed circuit board, a battery, a GNSS antenna, a vibration motor, one or more rear facing LEDs, and/or other features. The front clip may contain forward facing LEDs but may diffuse light under the helmet to alert the worker wearing the helmet as well. The front LED clip may connect to the rear component via an overhead strap with integrated power leads. The package is configured not to interfere with selected helmet accessories like the visor, face shield, hearing protection, or helmet-top headlamp currently compatible with the helmet models predominantly used by construction personnel.

The unit may be weatherproof with an external ON/OFF switch where the battery will charge in the OFF position while a 3.7-4.2V battery source is connected through the direct current (DC) barrel charge port. In some embodiments, the strap connecting power to the frontal LED component integrates one or more rear facing LEDs. Ultimately, many units may be stored in a convenient carrying case in which the units can be plugged in and charged from one single external plug that could be wall outlet alternating current (AC) or cigarette lighter DC from a vehicle.

Using the GNSS coordinates of the Smart Cone devices, the system is able to set off a polygon-shaped area where it is deemed safe for workers to be in. This area is created through the Smart Cone devices which may be in constant communication with the Base Station. The Base Station may be able to precisely track the position of each cone with the error being reduced by RTK corrections. Once this area is set, the system uses an alert system with two different signals that provide auditory, visual and haptic warnings to the workers. The initial alert may be a low-level alert which gets triggered to warn a worker when the worker is at or approaching the boundary of the safe zone or notify them when they have entered the area. The other alert is a high-level alert that may warn the workers when they have left the work zone area and are now in a more hazardous area.

The Smart Work Zone portable unit is a device that can be placed on any moving object such as a vehicle or piece of machinery and is used to provide additional warnings to workers. The portable unit constantly communicates its GNSS coordinates with the Base Station allowing alerts to be sent to the workers whenever a worker is in danger. The portable unit may send warnings whenever the object is in motion as to avoid situations where, for example, a non-moving vehicle would send a warning to a close-by worker. The portable unit sends a low-level alert when a worker is a first threshold distance away and a high-level alert when a worker is a second threshold distance away that is closer than the first threshold distance for the low-level alert.

In various embodiments, the geo-fencing is dynamic. The geo-fencing algorithm is able to recreate the polygon area whenever cones are added, removed, and/or relocated to a new location without having to reset the Base Station or any of the other components. In addition, in some embodiments, the Smart Cones do not need to be placed in a specific order as the geo-fencing algorithm may reorder the cones in a counterclockwise direction around the center of the polygon area.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

It is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequences where this is logically possible.

Embodiments of the present disclosure may be defined at least by the following clauses:

Clause 1. A system comprising: a plurality of smart cone devices, individual ones of the plurality of smart cone devices being configured to transmit smart cone device localization data; a wearable device comprising a processor configured to transmit worker localization data for a worker wearing the wearable device and to receive alerts; and a vehicle-to-everything base station comprising: a computing system comprising at least one hardware processor and a memory to store program instructions executable by the at least one hardware processor that, when executed by the computing system, cause the computing system to: process the smart cone device localization data to define a virtual geofence boundary for a safe area; process the worker localization data; broadcast a location of the worker wearing the wearable device; and in response to a vehicle or the worker approaching the virtual geofence boundary, provide an alert to at least one of: the worker wearing the wearable device, a passing motorist, or a connected and automated vehicle (CAV).

Clause 2. The system of clause 1, wherein the vehicle-to-everything base station supports Cellular Vehicle-to-Everything (C-V2X/PC5) communications and packet exchange for Society of Automotive Engineers (SAE) J2735 Basic Safety Messages (BSMs) and Personal Safety Message (PSMs) between CAVs and the worker wearing the wearable device.

Clause 3. The system of clauses 1 to 2, wherein the vehicle-to-everything base station further comprises a cellular communications link to transmit data including Basic Safety Messages (BSMs) and Personal Safety Messages (PSMs) to a cloud work zone information system.

Clause 4. The system of clauses 1 to 3, wherein the computing system is further configured to receive locations of at least one CAV that is out of range of the vehicle-to-everything base station.

Clause 5. The system of clauses 1 to 4, wherein the computing system is further configured to broadcast information about at least one of: a work zone geometry, a reduced speed limit, or a hazard to passing vehicles within range.

Clause 6. The system of clauses 1 to 5, wherein the processor of the wearable device is further configured to predict a potential collision between the worker wearing the wearable device and the passing motorist.

Clause 7. The system of clauses 1 to 6, wherein the wearable device further comprises a human-machine interface output to alert the worker wearing the wearable device of a collision threat or a geofence boundary crossing by at least one of: auditory feedback, visual feedback, or tactile feedback.

Clause 8. The system of clauses 1 to 7, wherein the individual ones of the plurality of smart cone devices comprise a respective add-on hardware component configured to be attached to a work zone drum or a work zone cone.

Clause 9. The system of clauses 1 to 8, wherein a boundary of the safe area is dynamically adjusted based at least in part on a work zone configuration.

Clause 10. The system of clauses 1 to 9, wherein one or more of the plurality of smart cone devices are configured to act as a repeater or a router on a wireless mesh network.

Clause 11. The system of clauses 1 to 10, wherein the vehicle-to-everything base station is further configured to communicate with a vehicle in response to determining that the vehicle is approaching the safe area.

Clause 12. The system of clauses 1 to 11, wherein the vehicle-to-everything base station is further configured to alert a worker wearing the wearable device in response to at least one of: determining that the worker is approaching a boundary of the safe area, or determining that a vehicle is approaching or is near the boundary of the safe area.

Clause 13. The system of clauses 1 to 12, wherein the vehicle-to-everything base station is further configured to use Global Navigation Satellite System (GNSS) and Real-Time Kinematic (RTK) positioning technology to compute a precise worker localization inside the safe area and to generate a virtual geofence using the smart cone devices.

Clause 14. The system of clauses 1 to 13, wherein the vehicle-to-everything base station is further configured with a cellular communications link to an off-site data center, to upload vehicle information, worker information, and work zone information or to retrieve vehicle information, worker information, and work zone information.

Clause 15. The system of clauses 1 to 14, wherein the vehicle-to-everything base station is further configured to provide one or more alerts to work zone workers and passing motorists including connected and automated vehicles (CAVs) in response to determining that a potential collision is imminent, or in response to determining that the worker is about to cross the virtual geofence boundary.

Clause 16. The system of clauses 1 to 15, wherein the wearable device comprises a safety vest device or a safety helmet device.

Clause 17. The system of clauses 1 to 16, wherein the alert to the worker wearing the wearable device is in response to: determining that the worker approaching or crossing the virtual geofence boundary defined as the safe area, or determining that the CAV is on a trajectory to collide with the worker wearing the wearable device and that a minimum time-to-collision threshold between the CAV and the worker has been reached.

Clause 18. The system of clauses 1 to 17, wherein the vehicle-to-everything base station is further configured to broadcast respective locations of a plurality of workers wearing respective wearable devices to one or more CAV within range of the vehicle-to-everything base station.

Clause 19. The system of clauses 1 to 18, wherein the vehicle-to-everything base station is further configured to communicate with cloud server applications via a cellular data interface to upload respective locations of a plurality of workers wearing respective wearable devices, respective locations of the plurality of smart cone devices, and respective locations of one or more CAV-equipped vehicles near the safe area.

Clause 20. A method, comprising: transmitting, by a plurality of smart cone devices, smart cone device localization data; transmitting, by a wearable device, worker localization data for a worker wearing the wearable device; processing, by a vehicle-to-everything base station, the smart cone device localization data to define a virtual geofence boundary for a safe area; processing, by the vehicle-to-everything base station, the worker localization data; broadcasting, by the vehicle-to-everything base station, a location of the worker wearing the wearable device; and in response to a vehicle or the worker approaching the virtual geofence boundary, providing, by the vehicle-to-everything base station, an alert to at least one of: the worker wearing the wearable device, a passing motorist, or a connected and automated vehicle (CAV).

As used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Therefore, at least the following is claimed:

1. A system comprising:
a plurality of smart cone devices, individual ones of the plurality of smart cone devices being configured to transmit smart cone device localization data;
a wearable device comprising a processor configured to transmit worker localization data for a worker wearing the wearable device and to receive alerts; and
a vehicle-to-everything base station comprising:
a computing system comprising at least one hardware processor and a memory to store program instructions executable by the at least one hardware processor that, when executed by the computing system, cause the computing system to:
process the smart cone device localization data to define a virtual geofence boundary for a safe area;
process the worker localization data;
broadcast a location of the worker wearing the wearable device; and
in response to a vehicle or the worker approaching the virtual geofence boundary, provide an alert to at least one of: the worker wearing the wearable device, a passing motorist, or a connected and automated vehicle (CAV).

2. The system of claim 1, wherein the vehicle-to-everything base station supports Cellular Vehicle-to-Everything (C-V2X/PC5) communications and packet exchange for Society of Automotive Engineers (SAE) J2735 Basic Safety Messages (BSMs) and Personal Safety Message (PSMs) between CAVs and the worker wearing the wearable device.

3. The system of claim 1, wherein the vehicle-to-everything base station further comprises a cellular communications link to transmit data including Basic Safety Messages (BSMs) and Personal Safety Messages (PSMs) to a cloud work zone information system.

4. The system of claim 1, wherein the computing system is further configured to receive locations of at least one CAV that is out of range of the vehicle-to-everything base station.

5. The system of claim 1, wherein the computing system is further configured to broadcast information about at least one of: a work zone geometry, a reduced speed limit, or a hazard to passing vehicles within range.

6. The system of claim 1, wherein the processor of the wearable device is further configured to predict a potential collision between the worker wearing the wearable device and the passing motorist.

7. The system of claim 1, wherein the wearable device further comprises a human-machine interface output to alert the worker wearing the wearable device of a collision threat or a geofence boundary crossing by at least one of: auditory feedback, visual feedback, or tactile feedback.

8. The system of claim 1, wherein the individual ones of the plurality of smart cone devices comprise a respective add-on hardware component configured to be attached to a work zone drum or a work zone cone.

9. The system of claim 1, wherein a boundary of the safe area is dynamically adjusted based at least in part on a work zone configuration.

10. The system of claim 1, wherein one or more of the plurality of smart cone devices are configured to act as a repeater or a router on a wireless mesh network.

11. The system of claim 1, wherein the vehicle-to-everything base station is further configured to communicate with a vehicle in response to determining that the vehicle is approaching the safe area.

12. The system of claim 1, wherein the vehicle-to-everything base station is further configured to alert a worker wearing the wearable device in response to at least one of: determining that the worker is approaching a boundary of the safe area, or determining that a vehicle is approaching or is near the boundary of the safe area.

13. The system of claim 1, wherein the vehicle-to-everything base station is further configured to use Global Navigation Satellite System (GNSS) and Real-Time Kinematic (RTK) technology to compute a precise worker localization inside the safe area and to generate a virtual geofence using the smart cone devices.

14. The system of claim 1, wherein the vehicle-to-everything base station is further configured with a cellular communications link to an off-site data center, to upload vehicle information, worker information, and work zone information or to retrieve vehicle information, worker information, and work zone information.

15. The system of claim 1, wherein the vehicle-to-everything base station is further configured to provide one or more alerts to work zone workers and passing motorists including connected and automated vehicles (CAVs) in response to determining that a potential collision is imminent, or in response to determining that the worker is about to cross the virtual geofence boundary.

16. The system of claim 1, wherein the wearable device comprises a safety vest device or a safety helmet device.

17. The system of claim 1, wherein the alert to the worker wearing the wearable device is in response to:
determining that the worker approaching or crossing the virtual geofence boundary defined as the safe area, or
determining that the CAV is on a trajectory to collide with the worker wearing the wearable device and that a minimum time-to-collision threshold between the CAV and the worker has been reached.

18. The system of claim 1, wherein the vehicle-to-everything base station is further configured to broadcast respective locations of a plurality of workers wearing respective wearable devices to one or more CAV within range of the vehicle-to-everything base station.

19. The system of claim 1, wherein the vehicle-to-everything base station is further configured to communicate with cloud server applications via a cellular data interface to upload respective locations of a plurality of workers wearing respective wearable devices, respective locations of the plurality of smart cone devices, and respective locations of one or more CAV-equipped vehicles near the safe area.

20. A method, comprising:
transmitting, by a plurality of smart cone devices, smart cone device localization data;
transmitting, by a wearable device, worker localization data for a worker wearing the wearable device;
processing, by a vehicle-to-everything base station, the smart cone device localization data to define a virtual geofence boundary for a safe area;
processing, by the vehicle-to-everything base station, the worker localization data;
broadcasting, by the vehicle-to-everything base station, a location of the worker wearing the wearable device; and
in response to a vehicle or the worker approaching the virtual geofence boundary, providing, by the vehicle-to-everything base station, an alert to at least one of: the worker wearing the wearable device, a passing motorist, or a connected and automated vehicle (CAV).
